(19) United States
(12) Patent Application Publication
(10) Pub. No.: US 2009/0321217 A1
(43) Pub. Date: Dec. 31, 2009

(54) BILL ACCETOR WITH A GATE CONTROL UNIT

(75) Inventors: Cheng-Kang Yu, Taipei City (TW); Wei-Jr Chen, Taipei City (TW); Shih-Chia Chen, Wu-Chi Town (TW); Tien-Yuan Chien, Taipei City (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: International Currency Technologies Corporation, Taipei City (TW)

(21) Appl. No.: 12/164,119

(22) Filed: Jun. 30, 2008

(51) Int. Cl. G07F 7/04

(52) U.S. Cl. 194/207; 194/206

(57) ABSTRACT

A bill acceptor includes a housing defining an insertion slot and a passage extending from said insertion slot, a transmission mechanism for delivering each inserted bill/license from the insertion slot to the passage and then to a bill box been attached to the housing, a gate controllable to open/close the insertion slot, an solenoid valve controllable to move the gate between the close position and the open position, a first media sensor disposed at a front side relative to the gate for driving the solenoid valve to open the gate upon detection of the insertion of a bill/license into the insertion slot, and a second media sensor disposed at a rear side relative to the gate and adapted for driving the solenoid valve to close the gate after the delivery of an inserted bill/license to the passage by the transmission mechanism.

### BACKGROUND OF THE INVENTION

1. Field of the Invention

The present invention relates to a bill acceptor for use in an automatic vending machine and more specifically, to an improved structure of bill acceptor that has a gate control unit therein for blocking the bill/license insertion slot to protect the internal parts against outside dust and to avoid interference of outside light with bill/license recognition operation.

2. Description of the Related Art

Following fast development of technology, our mode of living has been changed, and everything requires efficiency, time saving and quickness. In consequence, different automatic vending machines are used everywhere to sell different products without serviceman. These automatic vending machines are highly invited for the advantage of saving much labor and bringing convenience to people. Nowadays, Q-shops are seen in many places to provide different services to consumers. A Q-shop has the advantages of scientific intelligence, quick service and quick finish of payment. A Q-shop may provide automatic vending machines for vending drinks, cigarettes, tickets, ice creams, memorial coins, key rings or even hamburgers and noodles. Further, many virtual shops are established to make online shopping, allowing shoppers to shop across millions of products.

However, regular vending machines do not limit the sales to any person of any age. Therefore, regular vending machines commonly sell popular goods such as fruit juice beverages, carbonated beverages, food, etc. These vending machines cannot sell age-controlled merchandises such as cigarettes or alcohol drinks, or other controlled merchandises such as drugs, strong acid/alkaline detergent, or other hazardous items. To prohibit young children from buying age-controlled merchandises or unqualified people from buying controlled items, a vending machine for vending age-controlled or controlled merchandises must be equipped with a license recognition device to recognize the age and identity of the trader. Following the development of printing technology, evil persons may utilize high tech to make counterfeit bills and money laundering by means of purchasing commodities from automatic vending machines.

Further, an automatic vending machine may have a stop plate pivotally provided at the bill insertion slot to protect the internal parts against outside dust, but the stop plate not only is fragile but also cannot block external light. However, the arrangement of the stop plate is still not satisfactory in function because of the following drawbacks:
1. An evil person can damage the stop plate easily by means of a tool. Further, the stop plate cannot block external light from entering the internal bill/license passage, and external light may interfere with the recognition operation of the internal recognition device of the vending machine, resulting in recognition error.
2. The thin, light and small stop plate may be swung by an external force, and external dust will enter the machine to dust the precision components of the internal recognition device of the machine during accidental swinging of the stop plate. When the precision components of the recognition device are covered with dust, the recognition device may be unable to function well.

Therefore, it is desirable to provide an automatic vending machine with a bill/license acceptor that eliminates the aforesaid problems.

### SUMMARY OF THE INVENTION

The present invention has been accomplished under the circumstances in view. It is therefore the main object of the present invention to provide a bill acceptor for automatic vending machine, which improves bill/license verification accuracy and well protects the bill/license recognition device against external dust and interference of outside light.

According to one aspect of the present invention, the bill acceptor comprises a housing, which comprises an insertion slot for the insertion of a bill and a license selectively and a passage extending inwardly from the insertion slot to a bill box that is attached to the housing, a transmission mechanism mounted inside the housing and adapted for delivering each inserted bill/license from the insertion slot to a predetermined location in the passage for recognition and returning the license to the insertion slot after recognition and delivering each recognized bill to the bill box, a gate control unit, which comprises a gate controllable to open the insertion slot for the insertion of a bill/license through the bill insertion slot into the passage and to close the insertion slot after the insertion of a bill/license pass through the bill insertion slot into the passage and an solenoid valve controllable to move the gate between a close position to close the insertion slot and an open position to open the insertion slot, and a detection module, which comprises a first media sensor disposed at a front side relative to the gate and adapted for detecting the insertion of a bill/license into the insertion slot and the solenoid valve is activated to open the gate upon insertion of a bill/license and a second media sensor disposed at a rear side relative to the gate and adapted for detecting the delivery of an inserted bill transmitted from the insertion slot into the passage by the transmission mechanism and the solenoid valve is deactivated to close the gate after the delivery of an inserted bill/license to the passage. The gate protects the internal parts of the bill acceptor against outside dust, and blocks outside light from entering the passage during recognition of the inserted bill or license by the bill acceptor.

According to another aspect of the present invention, the bill acceptor further comprises a transmission mechanism, which is comprised of a motor, a plurality of bill-transfer rollers and transmission belts for moving each inserted bill/license, and a recognition unit, which comprises a sampling module for picking up an image of an inserted license and verifying the authenticity of the license and data of date of birth carrying on the license and an optical identification module adapted for identifying the authenticity and value of an inserted bill.

### BRIEF DESCRIPTION OF THE DRAWINGS

FIG. 1 is an elevational view of a bill acceptor according to the present invention.

FIG. 2 is an exploded view of the bill acceptor shown in FIG. 1.

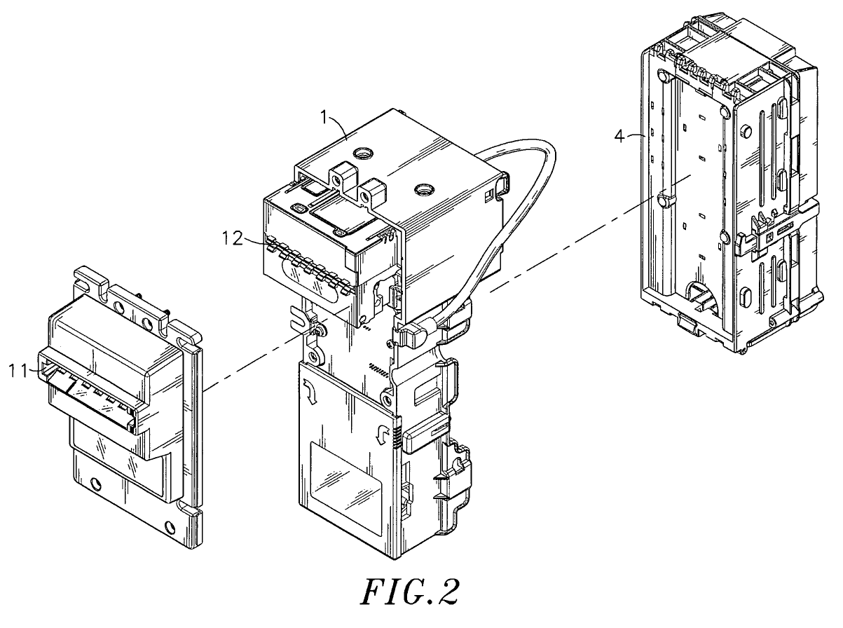

FIG. 3 is an exploded view of a part of the present invention, showing the structure of the gate control unit.

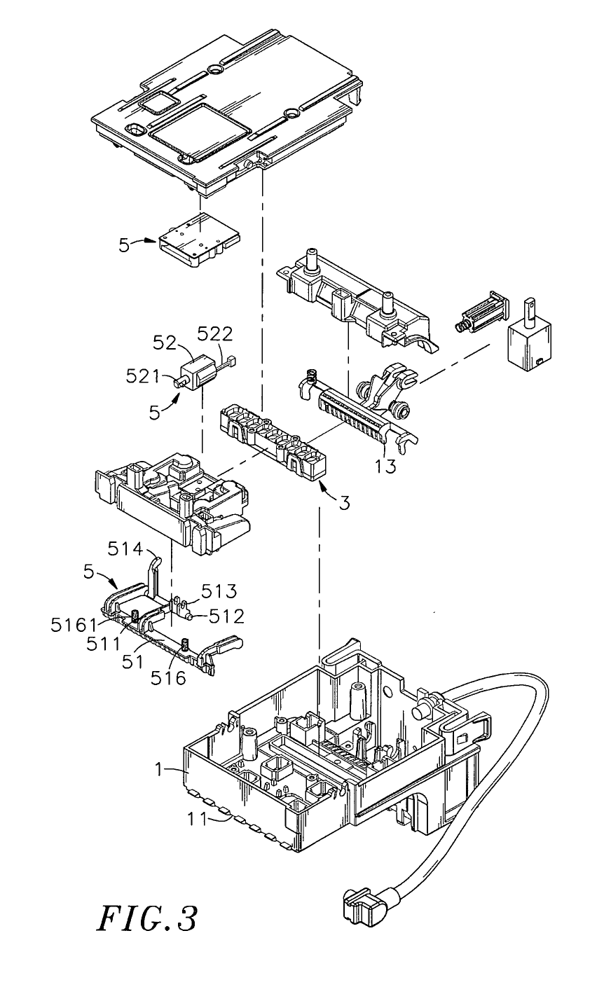

FIG. 4 is an exploded view of a part of the present invention, showing the arrangement of a part of the transmission mechanism, the recognition unit and the detection module in the housing.

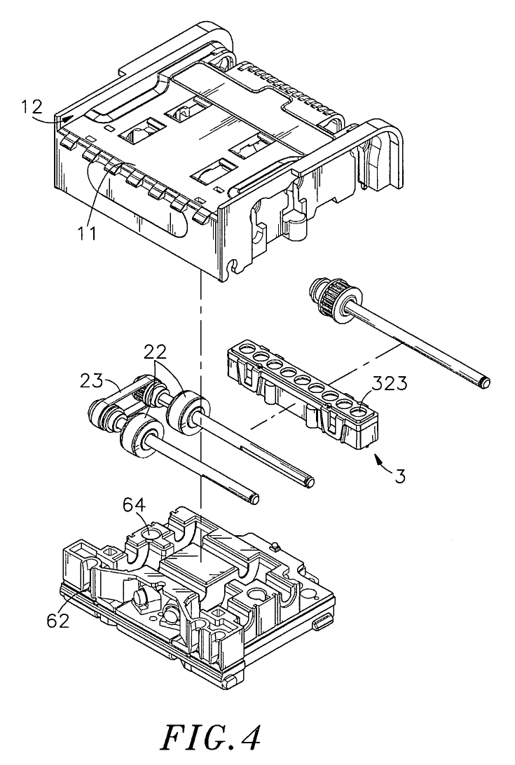

FIG. 5 is a sectional side view of the bill box in accordance with the present invention.

FIG. 6 is a schematic sectional side view in an enlarged scale of a part of the present invention, showing a bill inserted through the insertion slot into the passage of the bill box.

FIG. 7 is a schematic sectional side view in an enlarged scale of a part of the present invention, showing a license inserted through the insertion slot into the passage of the bill box.

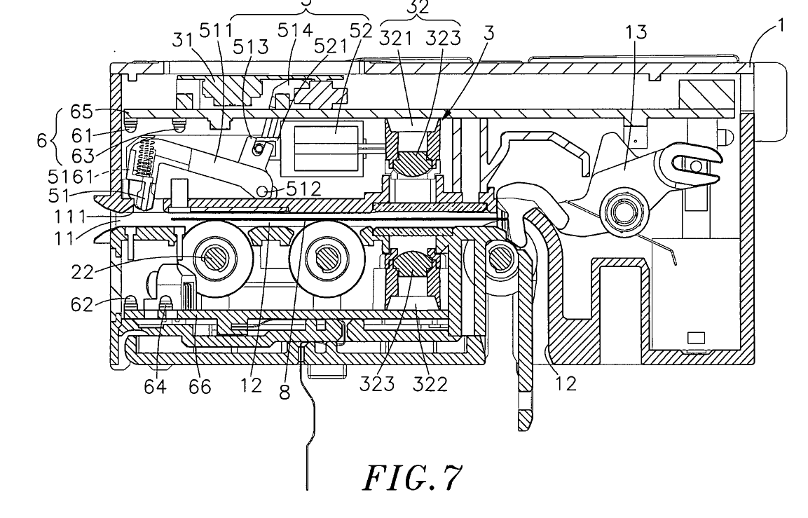

FIG. 8 corresponds to FIG. 7, showing the inserted license entered the passage and the gate closed.

### DETAILED DESCRIPTION OF THE PREFERRED EMBODIMENT

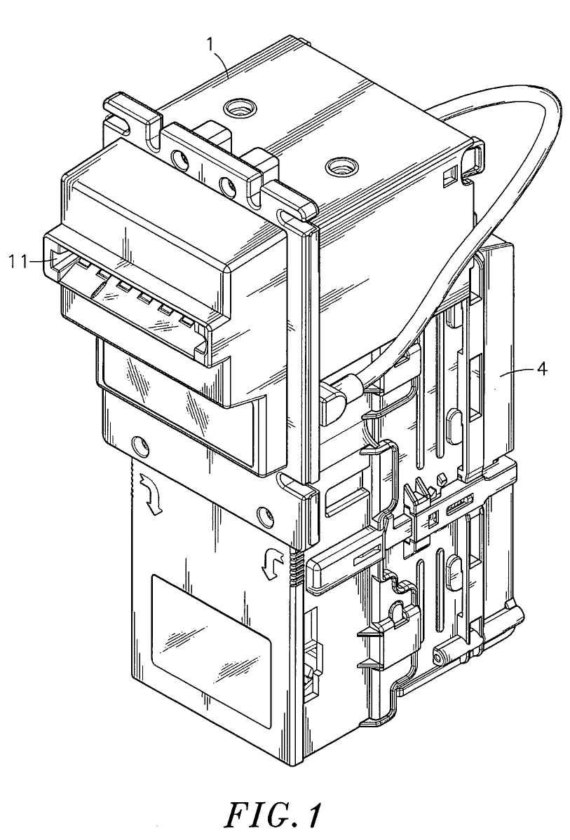

Referring to FIGS. 1˜4, a bill acceptor in accordance with the present invention is shown comprising a housing 1, a transmission mechanism 2, a recognition unit 3, a bill box 4, a gate control unit 5 and a detection module 6.

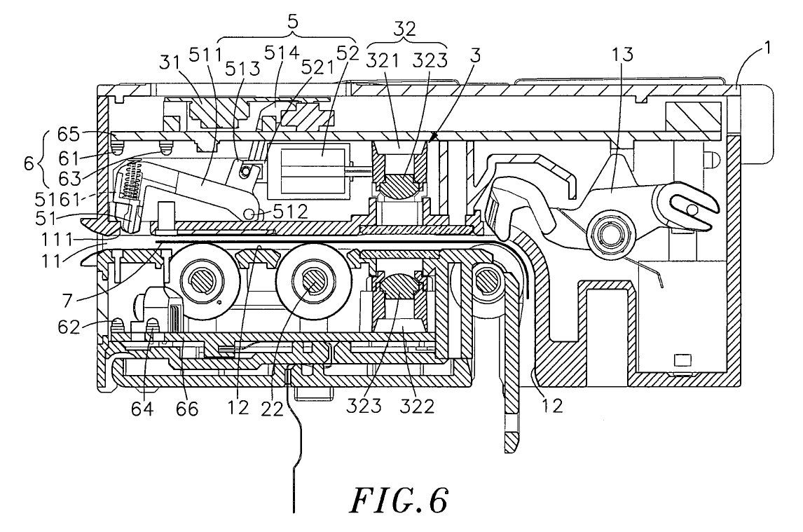

The housing 1 houses the transmission mechanism 2, the recognition unit 3, the bill box 4, the gate control unit 5 and the detection module 6, having an insertion slot 11, an inside hole 111 (shown in FIG. 6) in communication with the insertion slot 11 at one side, a passage 12 extending from the insertion slot 11, and an anti-theft hook 13 provided at a middle turn of the passage 12.

The transmission mechanism 2 is mounted around the passage 12, comprising a motor 21, a set of bill-transfer rollers 22, transmission belts 23, an encoder wheel 211, an optical sensor 212, and a bill-pressing device 24. The encoder wheel 211 and the optical sensor 212 are adapted for counting the revolving speed of the bill-transfer rollers 22. The motor 21 is controlled to drive the bill-transfer rollers 22 and the transmission belts 23, transferring each inserted bill 7. The bill-pressing device 24 is adapted for moving each inserted bill 7 out of the passage 12 into the bill box 4.

The recognition unit 3 is provided at top and bottom sides of the passage 12, comprising a sampling module 31 and an optical identification module 32. The sampling module 31 is adapted for reading and identifying anti-counterfeit characteristics and character data of a license 8 inserted into the insertion slot 11. The optical identification module 32 comprises a plurality of light emitting devices 321, a plurality of optical sensors 322 respectively axially aimed at the light emitting devices 321, and lenses 323 respectively set between the light emitting devices 321 and the optical sensors 322.

The bill box 4 is mounted to the housing 1 corresponding to the rear end of the passage 12 and opposing the bill-pressing device 24, having a bill-bearing board 41 and spring members 42 that supports the bill-bearing board 41. The spring members 42 impart a pressure to the bill-bearing board 41 in direction toward the passage 12 and the bill-pressing device 24. The bill-bearing board 41 is adapted for receiving each bill 7 that is moved out of the passage 12 by the bill-pressing device 24.

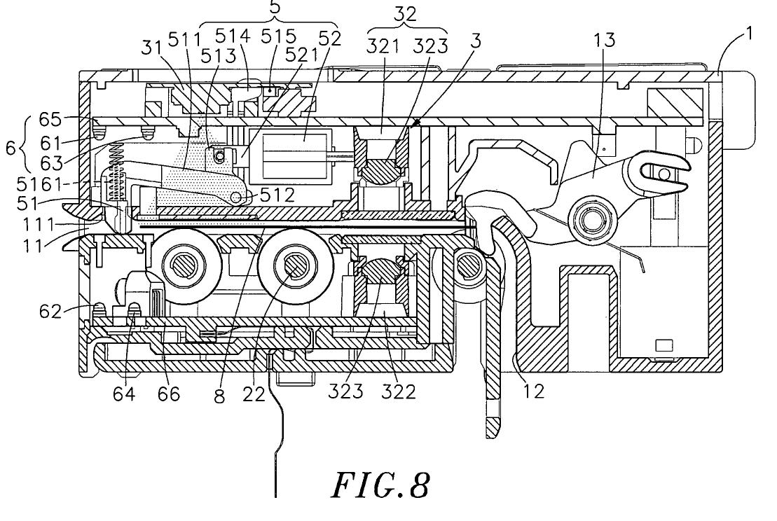

The gate control unit 5 comprises a gate 51 and a solenoid valve 52. The solenoid valve 52 comprises a driving rod 521, and a power line 522 electrically connected to power supply. The gate 51 is mounted in the inside hole 111 and movable to close/open the passage 12, comprising a link 511, an axle 512 connected with the distal end of the link 511, a coupling portion 513 upwardly extending from the periphery of the axle 512 and coupled to the driving rod 521 of the solenoid valve 52, a probe 514 upwardly extending from the periphery of the axle 512, and a plurality of upright pins 516. The gate control unit 5 further comprises a displacement sensor 515 (shown in FIG. 8) adapted for detecting displacement of the probe 514, and a plurality of spring members 5161 (shown in FIG. 6) respectively sleeved onto the upright pins 516.

The detection module 6 comprises a top circuit board 65 disposed at the top side relative to the insertion slot 11 and the passage 12 and electrically connected with the power line 522 of the solenoid valve 52, a bottom circuit board 66 disposed at the bottom side relative to the insertion slot 11 and the passage 12 and electrically connected with the power line 522 of the solenoid valve 52, a first media sensor 61 installed in the top circuit board 65 corresponding to the insertion slot 11 and adapted for transmitting a signal, a first signal receiver 62 installed in the bottom circuit board 66 corresponding to the insertion slot 11 and adapted for receiving the signal from the first media sensor 61, a second media sensor 63 installed in the top circuit board 65 corresponding to the passage 12 and adapted for transmitting a signal, a second signal receiver 64 installed in the bottom circuit board 66 corresponding to the passage 12 and adapted for receiving the signal from the second media sensor 63. The first media sensor 61 and the first signal receiver 62 are disposed at a front side relative to the gate 51, the second media sensor 63 and the second signal receiver 64 are disposed at a back side relative to the gate 51, and the signals transmitted from the first media sensor 61 and the second sensor 62 are used to control the solenoid valve 52 open or close.

The aforesaid sampling module 31 comprises an image sensor adapted to pick up the image of the anti-counterfeit characteristics of a license 8 that is inserted through the insertion slot 11 into the passage 12. The image sensor can be a charge coupled device (CCD), complementary metal-oxide semiconductor (CMOS) image sensor or any suitable type image sensor. The anti-counterfeit characteristics include watermarking, steel stamp, invisible barcode, laser label, and etc.

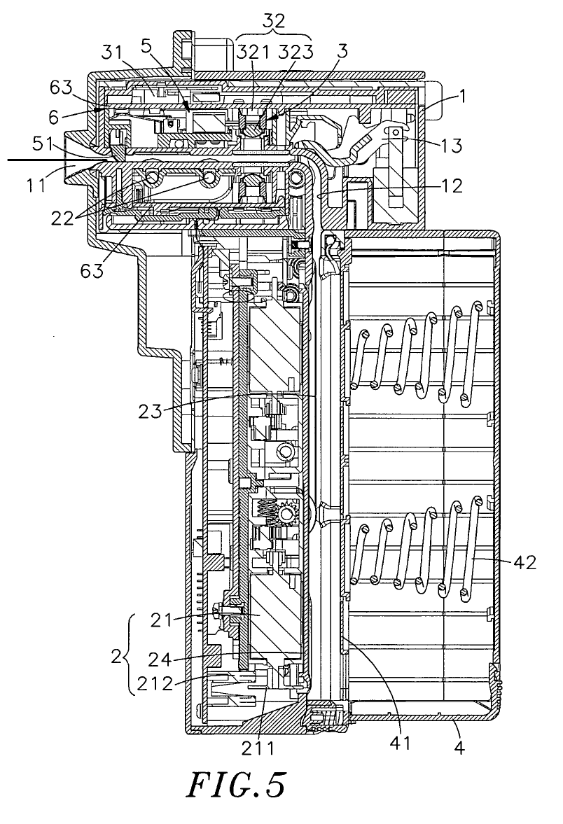

Referring to FIGS. 5˜8 again, the bill acceptor is installed in an automatic vending machine for the insertion of a bill 7 or license 8. When a bill 7 or license 8 is inserted through the insertion slot 11 of the bill acceptor into the passage 12, the inserted bill 7 or license 8 shields the first media sensor 61, blocking the first signal receiver 62 from receiving the output signal of the first media sensor 61. When the first signal receiver 62 receives no signal from the first media sensor 61, the top circuit board 65 and the bottom circuit board 66 are caused to drive the solenoid valve 52, causing the coupling portion 513 to have the fan-shaped displacement by taking the axle 512 as an axle center, thereby lifting the gate 51 from the insertion slot 11. When the gate 51 is lifted, the probe 514 shields the displacement sensor 515 to confirm the displacement of the coupling portion 513, meanwhile, the spring members 5161 sleeved onto the upright pins 516 are compressed, causing the top circuit board 65 and the bottom circuit board 66 to start the transmission mechanism 2 and the recognition unit 3. At this time, the motor 21 drives the bill-transfer rollers 22 and the transmission belts 23 to transfer the inserted bill 7 or license 8 forwards. During operation of the motor 21, the encoder wheel 211 is rotated with the bill-transfer rollers 22 synchronously, causing the optical sensor 212 to count the number of turns of the bill-transfer rollers 22. Subject to the number of turns of the bill-transfer rollers 22, the moving distance of the inserted bill 7 or license 8 is calculated. Therefore, the inserted bill 7 or license 8 can be accurately delivered to a predetermined location for examination by the sampling module 31 and the optical identification module 32 of the optical recognition unit 3 to recognize the value, authenticity, and/or data of date of birth of the inserted bill 7 or license 8.

When one bill 7 entered the passage 12, the second signal receiver 64 receives the signal from the second media sensor 63 again, causing the top circuit board 65 and the bottom circuit board 66 to stop the solenoid valve 52. At this time, the spring force of the spring members 5161 forces the gate 51 downwards through the inside hole 111 into the insertion slot 11 to block the insertion slot 11, prohibiting the insertion of any external body. Further, the gate 51 is made out of an opaque material. When the gate 51 is closed, it protects the passage 12 against outside dust and blocks outside light from passing through the insertion slot 11 into the passage 12, allowing the optical recognition unit 3 to recognize the bill 7 or license 8 accurately, preventing a recognition error.

As stated above, the bill acceptor comprises an insertion slot 11 in the front side of the housing 1 thereof for the insertion of a bill 7 or license 8, a gate control unit 5 controllable to open the insertion slot 11 for the insertion of a bill 7 or license 8 and to close the insertion slot 11 after the insertion of a bill 7 or license 8. When the gate control unit 5 closes the insertion slot 11 after the insertion of a bill 7 or license 8, it blocks outside light from passing through the insertion slot 11 into the inside of the bill acceptor, preventing interference of external light with the operation of a sampling module 31 and an optical identification module 32 inside the bill acceptor and protecting the internal devices against outside dust.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising:
a housing mounted with a bill box, said housing comprising an insertion slot for the insertion of a bill and a license selectively and a passage extending inwardly from said insertion slot to said bill box;
a transmission mechanism mounted inside said housing and adapted for delivering each inserted bill/license from said insertion slot to a predetermined location in said passage for recognition;
a gate control unit mounted inside said housing around said insertion slot, said gate control unit comprising a gate controllable to open said insertion slot for the insertion of a bill/license through said bill insertion slot into said passage and to close said insertion slot after the insertion of a bill/license pass through said bill insertion slot into said passage, and an solenoid valve controllable to move said gate between a close position to close said insertion slot and an open position to open said insertion slot; and
a detection module mounted inside said housing around said insertion slot, said detection module comprising a first media sensor disposed at a front side relative to said gate and adapted for detecting the insertion of a bill/license into said insertion slot and driving said solenoid valve to open said gate upon detection of the insertion of a bill/license into said insertion slot, and a second media sensor disposed at a rear side relative to said gate and adapted for detecting the delivery of an inserted bill/license from said insertion slot into said passage by said transmission mechanism and driving said solenoid valve to close said gate after the delivery of an inserted bill/license to said passage.

2. The bill acceptor as claimed in claim 1, wherein said housing has an inside hole through which said gate of said gate control unit is movable in and out of said insertion slot to block/open said insertion slot.

3. The bill acceptor as claimed in claim 1, wherein said gate of said gate control unit is made out of an opaque material.

4. The bill acceptor as claimed in claim 1, wherein said gate has a plurality of upright pins arranged at a top side thereof, and a plurality of spring members respectively sleeved onto said upright pins and stopped between said gate and an inside part of said housing.

5. The bill acceptor as claimed in claim 1, wherein said gate comprises a link, an axle connected to one end of said link opposite to said gate, and a coupling portion coupled to said solenoid valve for enabling said solenoid valve to move said gate between said close position and said open position.

6. The bill acceptor as claimed in claim 1, further comprising a recognition unit mounted inside said housing around said passage, said recognition unit comprising a sampling module for picking up an image of an inserted license and verifying the authenticity of the license and data of date of birth carrying on the license.

7. The bill acceptor as claimed in claim 6, wherein said recognition unit further comprises an optical identification module adapted for identifying the authenticity and value of an inserted bill.

8. The bill acceptor as claimed in claim 1, wherein said transmission mechanism comprises a bill-pressing device adapted for moving each inserted bill out of said passage into said bill box; said bill box comprises a bill-receiving bearing board adapted for receiving each bill that is moved away from said passage by said bill-pressing device.

9. The bill acceptor as claimed in claim 1, wherein said transmission mechanism comprises a motor, a plurality of bill-transfer rollers and transmission belts rotatable by said motor for carrying each inserted bill from said insertion slot through said passage toward said bill box, and an encoder and optical sensor means adapted for counting the number of turns of the rotation of said bill-transfer rollers.
